(19) United States
(12) Patent Application Publication
(10) Pub. No.: US 2014/0050392 A1
(43) Pub. Date: Feb. 20, 2014

(54) METHOD AND APPARATUS FOR DETECTING AND TRACKING LIPS

(71) Applicant: SAMSUNG ELECTRONICS CO., LTD., Suwon-si (KR)

(72) Inventors: Xuetao Feng, Beijing (CN); Xiaolu Shen, Beijing (CN); Hui Zhang, Beijing (CN); Ji Yeun Kim, Seoul (KR); Jung Bae Kim, Hwaseong-si (KR)

(73) Assignee: SAMSUNG ELECTRONICS CO., LTD., Suwon-si (KR)

(21) Appl. No.: 13/967,435

(22) Filed: Aug. 15, 2013

(30) Foreign Application Priority Data
Aug. 15, 2012 (CN) 201210290290.9
May 7, 2013 (KR) 10-2013-0051387

(51) Int. Cl. G06K 9/00

(52) U.S. Cl. CPC G06K 9/00281
USPC 382/159; 382/218

(57) ABSTRACT

Provided is a method of detecting and tracking lips accurately despite a change in a head pose. A plurality of lips rough models and a plurality of lips precision models may be provided, among which a lips rough model corresponding to a head pose may be selected, such that lips may be detected by the selected lips rough model, a lips precision model having a lip shape most similar to the detected lips may be selected, and the lips may be detected accurately using the lips precision model.

### CROSS-REFERENCE TO RELATED APPLICATIONS

This application claims priority to Chinese Patent Application No. 201210290290.9, filed on Aug. 15, 2012, and Korean Patent Application No. 10-2013-0051387, filed on May 7, 2013, in the Korean Intellectual Property Office, the disclosures of which are incorporated herein by reference.

### BACKGROUND

1. Field

One or more embodiments disclosed herein relate to image recognition technology, and more particularly, to a method and apparatus for detecting and/or tracking lips.

2. Description of the Related Art

In video-based human-computer interaction (HCl), detecting and tracking facial motions and expressions is important. For example, an animation model designed to animate and morph a face has a wide range of applications, for example, interactive entertainment, game production, and in the movie industry. Most digital cameras are provided with a shutter to control a blink. Also, in the field of voice recognition, a shape and a motion of lips may assist with voice recognition. In particular, a shape and a motion of lips may improve accuracy of voice recognition in an environment in which background noise is present.

Among all facial components, a shape change of the lips is the most complex. Various changes may occur in the shape of the lips due to the movement of facial muscles when representing various facial expressions. Accordingly, accurate positioning and tracking of a position and shape of the lips is more difficult than other facial components.

Generally, lips detection and tracking technologies are implemented by processing a face image directly. For example, a face image may be segmented using the fact that a lip color is different from a skin color. In the segmented face image, a search may be conducted for a region including the lips. Subsequently, a lip contour may be detected within the region.

### SUMMARY

The foregoing and/or other aspects are achieved by providing a method of detecting lips, the method including estimating a head pose in an input image, selecting a lips rough model corresponding to the estimated head pose among a plurality of lips rough models, executing an initial detection of lips using the selected lips rough model, selecting a lips precision model having a lip shape most similar to a shape of the initially detected lips among a plurality of lips precision models, and detecting the lips using the selected lips precision model. When estimating the head pose in the input image, the head pose may be estimated based on an estimated position of the lips.

The plurality of lips rough models may be obtained by training lip images of a first multi group as a training sample. Lip images of each group of the first multi group may be used as one training sample set, and may be used to train a corresponding lips rough model. The lip images of each group of the first multi group may have the same head pose or similar head poses. Also, the plurality of lips precision models may be obtained by training lip images of a second multi group as a training sample. Lip images of each group of the second multi group may be used as one training sample set, and may be used to train a corresponding lips precision model. The lip images of each group of the second multi group may have the same head pose or similar head poses. Also, the lip image of each group of the second multi group may be divided into a plurality of subsets based on a lip shape. The lips precision model may be trained using the subsets. Each of the subsets may be used as one training sample set, and may be used to train a corresponding lips precision model. Each lip image of the training sample may include a key point of a lip contour.

The lips rough model may include at least one of a shape model and a presentation model. Also, the lips precision model may include at least one of a shape model and a presentation model.

The shape model may be used to model the lip shape. The shape model may correspond to a similarity transformation on an average shape and a weighted sum of at least one shape primitive reflecting a shape change. The average shape and the shape primitive may be set to be intrinsic parameters of the shape model. A parameter for the similarity transformation and a shape parameter vector of the shape parameter for weighting the shape primitive may be set to be variables of the shape model.

The presentation model may be used to model a presentation of the lips. The presentation model may correspond to an average presentation of the lips and a weighted sum of at least one presentation primitive reflecting a presentation change. The average presentation and the presentation primitive may be set to be intrinsic parameters of the presentation model. A weight for weighting the presentation primitive may be set to be a variable of the presentation model.

The using of the lips rough model may further include calculating a weighted sum of at least one term of a presentation bound term, an internal transform bound term, and a shape bound term. The presentation bound term may indicate a difference between the presentation of the detected lips and the presentation model. The internal transform bound term may indicate a difference between the shape of the detected lips and the average shape. The shape bound term may indicate a difference between the shape of the detected lips and a pre-estimated position of the lips in the input image.

The detecting of the lips using the lips precision model may include calculating a weighted sum of at least one term of a presentation bound term, an internal transform bound term, a shape bound term, and a texture bound term. The presentation bound term may indicate a difference between the presentation of the detected lips and the presentation model. The internal transform bound term may indicate a difference between the shape of the detected lips and the average shape. The shape bound term may indicate a difference between the shape of the detected lips and the shape of the initially detected lips. The texture bound term may indicate a texture change between a current frame and a previous frame.

Alternatively, the detecting of the lips using the lips precision model may include calculating a weighted sum of at least one term of a presentation bound term, an internal transform bound term, a shape bound term, and a texture bound term. The presentation bound term may indicate a difference between the presentation of the detected lips and the presentation model. The internal transform bound term may indicate a difference between the shape of the detected lips and the average shape. The shape bound term may indicate a difference between the shape of the detected lips and the shape of the initially detected lips. The texture bound term may indicate a texture change between a current frame and a previous frame.

The average shape may indicate an average shape of the lips included in a training sample set for training the shape model, and the shape primitive may indicate one change of the average shape.

The method of detecting lips may further include selecting an eigenvector of a covariance matrix for shape vectors of all or a portion of training samples in a training sample set, and setting the eigenvector of the covariance matrix to be the shape primitive.

When a sum of eigenvalues of a covariance matrix for shape vectors of a predetermined number of training samples in the training sample set is greater than a preset percentage of a sum of eigenvalues of a covariance matrix for shape vectors of all training samples in the training sample set, the eigenvectors of the covariance matrix for the shape vectors of the predetermined number of training samples may be set to be a predetermined number of shape primitives.

The average presentation may denote an average value of presentation vectors in a training sample set for training the presentation model, and the presentation primitive may denote one change of the average presentation vector.

An eigenvector of a covariance matrix for shape vectors of all or a portion of training samples in the training sample set may be selected, and may be set to be the shape primitive.

When a sum of eigenvalues of a covariance matrix for shape vectors of a predetermined number of training samples in the training sample set is greater than a preset percentage of a sum of eigenvalues of a covariance matrix for shape vectors of all training samples in the training sample set, the eigenvectors of the covariance matrix for the shape vectors of the predetermined number of training samples may be set to be a predetermined number of shape primitives.

The lip shape may be represented through coordinates of a key point of a lip contour.

The presentation vector may include a pixel value of a pixel of a lip texture image unrelated to a shape of the lips.

The method of detecting lips may further include obtaining the presentation vector by the training. The obtaining of the presentation vector by the training may include obtaining a lip texture image unrelated to a shape of the lips by mapping a pixel inside the lips and a pixel within a preset range outside the lips onto the average shape of the lips based on a location of a key point of a lip contour represented in the training sample, generating a plurality of gradient images for a plurality of directions of the lip texture image unrelated to the shape, and obtaining the presentation vector by transforming the lip texture image unrelated to the shape and the plurality of gradient images in a form of a vector and by interconnecting the transformed vectors.

The method of detecting lips may further include obtaining the lip texture image unrelated to the shape of the lips by the training. The obtaining of the lip texture image unrelated to the shape by the training may include mapping a pixel inside the lips of the training sample and a pixel within a preset range outside the lips to a corresponding pixel in the average shape based on a key point of a lip contour in the training sample and the average shape.

The method of detecting lips may further include obtaining the lip texture image unrelated to the shape of the lips by the training. The obtaining of the lip texture image unrelated to the shape of the lips by the training may include dividing grids over the average shape of the lips using a preset method based on a key point of a lip contour representing the average shape of the lips in the average shape of the lips, dividing grids over a training sample including the key point of the lip contour using the preset method based on the key point of the lip contour, and mapping a pixel inside the lips of the training sample and a pixel within a preset range outside the lips to a corresponding pixel in the average shape based on the grid.

The shape bound term E₁₃ may be set by the equation:

E₁₃=(s−s^{*})^{T}W(s−s^{*})

Here, W denotes a diagonal matrix for weighting, and s* denotes a position of the initially detected lips in the input image. s denotes an output of the shape model.

The texture bound term (E₂₄) may be set by the equation:

$${E}_{24} = {\sum }_{i = 1}^{i} {[ P ( I ( s ( {x}_{i} ) ) ) ]}^{2}$$

Here, P(I₍ₛ₍xᵢ))) denotes a reciprocal of a probability density obtained using a value of I(s(xi)) as an input of a Gaussian mixture model (GMM) corresponding to a pixel xi, I(s(xᵢ)) denotes a pixel value of a pixel of a location s(xᵢ) in the input image, and s(xᵢ) denotes a location of a pixel xᵢ in the input image.

The foregoing and/or other aspects are achieved by providing an apparatus for detecting lips. The apparatus for detecting lips may include a pose estimating unit to estimate a head pose in an input image, a lips rough model selecting unit to select a lips rough model corresponding to the estimated head pose among a plurality of lips rough models, a lips initial detecting unit to execute an initial detection of lips using the selected lips rough model, a lips precision model selecting unit to select a lips precision model having a lip shape most similar to a shape of the initially detected lips among a plurality of lips precision models, and a precise lips detecting unit to detect the lips using the selected lips precision model.

The foregoing and/or other aspects are achieved by providing lips detecting method that may include selecting a lips rough model from among a plurality of lips rough models, executing an initial detection of lips using the selected lips rough model, selecting a lips precision model having a lip shape according to a shape of the initially detected lips from among a plurality of lips precision models, and detecting the lips using the selected lips precision model.

The foregoing and/or other aspects are achieved by providing a method and apparatus for detecting or tracking lips that may be adapted to a variety of changes of a lip shape and may detect a key point of a lip contour accurately. Also, when a variety of changes occur in a head pose, the lip shape in the image or video may be changed, however, according to the method and apparatus for detecting and/or tracking lips according to an exemplary embodiment, the key point of the lip contour may be detected accurately.

The foregoing and/or other aspects are achieved by providing a method and apparatus for detecting/tracking lips that may ensure high rigidity against the influence of an environmental illumination and an image collecting apparatus. The method and apparatus for detecting/tracking lips according to an exemplary embodiment may detect a key point of a lip contour accurately even in an image having an unbalance lighting, a low brightness, and/or a low contrast. Also, according to an exemplary embodiment, provided may be a new lips modeling for an apparatus and method for detecting/tracking lips with improved accuracy and robustness of detection and/or tracking of the lips.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 is a flowchart illustrating a method of detecting lips according to an exemplary embodiment;

FIG. 2 is a diagram illustrating a relative position of lips in a face region according to an exemplary embodiment;

FIG. 3 is a diagram illustrating a key point of a lip contour according to an exemplary embodiment;

FIG. 4 is a flowchart illustrating a method of obtaining a presentation vector according to an exemplary embodiment;

FIG. 5 is a flowchart illustrating a method of obtaining a lip texture image unrelated to a shape according to an exemplary embodiment;

FIG. 6 is a diagram illustrating an example of grids divided based on a vertex of an average shape according to an exemplary embodiment;

FIG. 7 is a diagram illustrating an example of dividing grids over a lip image set as a training sample;

FIG. 8 is a diagram illustrating a detecting result of an input image in a process of minimizing an energy function;

FIG. 9 is a flowchart illustrating modeling of a texture model according to an exemplary embodiment;

FIG. 10 is a flowchart illustrating a method of updating a texture model according to an exemplary embodiment; and

FIG. 11 is a block diagram illustrating an apparatus for detecting lips according to an exemplary embodiment.

### DETAILED DESCRIPTION

Hereinafter, exemplary embodiments are described in detail by referring to the accompanying drawings.

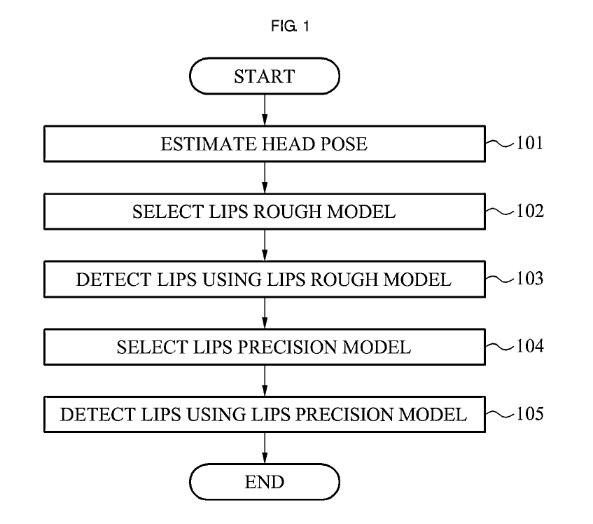

FIG. 1 is a flowchart illustrating a method of detecting lips according to an exemplary embodiment.

Referring to FIG. 1, in operation 101, a position of lips and a head pose including the lips may be estimated in an input image. A predetermined error may occur in the position of the lips estimated in operation 101, and an accurate position of lips may be obtained through a subsequent operation. Accordingly, operation 101 may correspond to an operation for initial estimation of a position of lips. The position of the lips may be represented by an array of key points surrounding the lips or a rectangle surrounding a region of the lips.

Here, the position of the lips may be estimated using various methods, and the position of the lips may be estimated using conventional estimation methods for the lips. For example, a fitting system and method has been proposed, of which reference is made in Chinese Patent Application No. 201010282950.X titled, Target fitting system and method, which is incorporated herein by reference. The method may be used to position key points of the lips. Further reference is made to U.S. Pat. No. 7,835,568 directed to a method of setting a rectangle surrounding lips by analyzing a non-skin color region using squares, which is also incorporated herein by reference.

Also, to reduce a detection range, a face may be detected before estimating the position of the lips, and the position of the lips may be estimated within the detected face. In this instance, the face may be detected in an image using various face detection techniques.

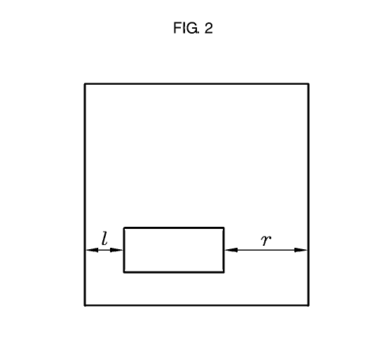

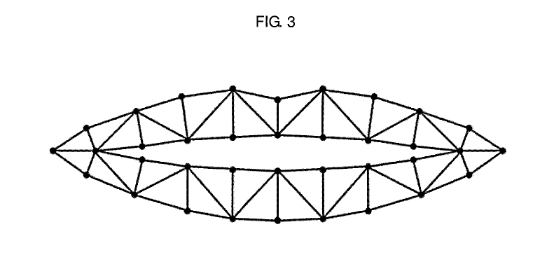

A head pose may be determined using the detected position of the lips. More particularly, because an initial detection of a position of lips is executed in operation 101, a distance/between a left boundary of the lips and a left boundary of the face and a distance r between a right boundary of the lips and a right boundary of the face may be obtained based on the detected position of the lips. A more detailed description is provided below with reference to FIG. 2. As shown in FIG. 3, a larger square may represent a boundary of a face and a smaller square may represent left and right boundaries of the lips.

The head pose may be represented using /and r. According to Bayer's theorem, based on a premise that a relative position of lips in a face, for example, l/r, is obtained previously, a probability of a head assuming a particular pose is proportional to a probability of l/r in a training image of a head pose.

Also, according to the analysis, the head pose may be represented using r/l , l/(l+r), and r/(l +r).

Also, the head pose may be obtained by analyzing an image through conventional head pose recognition techniques.

In operation 102, a lips rough model corresponding to the head pose may be selected based on the head pose among a plurality of lips rough models. For example, a lips rough model having a head pose most similar to the head pose may be selected.

The plurality of lips rough models may be obtained by training lip images of a multi group as a training sample, and lip images of each group of the multi group may have a preset head pose. Lip images of different groups may have different head poses, and lip images of the same group may have the same head pose or similar head poses. For example, a series of lip images may be collected and may be set to be a training sample. The lip images may have different shapes, different head poses, and/or different lighting conditions. Also, the lip images collected based on the head pose may be divided into different subsets, and each of the subsets may correspond to one head pose. For example, the lip images may be divided based on an angle at which a head is rotated in a horizontal direction.

Subsequently, a location of a key point of a lip contour, for example, a lip corner, a center of an upper lip, and a center of a lower lip, may be indicated manually in each lip image. Finally, a plurality of lips rough models may be obtained by training, for each subset, an image having a key point of a lip contour indicated in the image. For example, when an image having a key point of a lip contour indicated in the image is trained using one subset, a corresponding lips rough model may be obtained. Using the obtained lips rough model, a key point of a lip contour may be detected in a lip image having a most similar corresponding head pose. Also, the lips rough model may be modeled and trained using conventional model recognition techniques. For example, the lips rough model may be trained using a training method, for example, AdaBoost, based on different subsets.

In operation 103, an initial detection of the lips may be executed in the image using the selected lips rough model. The detected lips may be represented by a location of a key point of a lip contour. FIG. 3 illustrates a key point of a lip contour according to an exemplary embodiment. As shown in FIG. 3, a lip region grid may be generated using the key point of the lip contour.

In operation 104, based on a result of operation 103, a lips precision model may be selected from among a plurality of lips precision models. More particularly, a lips precision model including a lip shape most similar to the lip shape detected in operation 103 may be selected among a plurality of lips precision models.

The plurality of lips precision models may be obtained by training lip images of a multi group as a training sample, and lip images of each group of the multi group may have a preset shape. For example, lip images of different groups may have different head poses. The modeling of the lips precision model may be similar to the modeling of the lips rough model. For example, a series of lip images may be collected and may be determined to be a training sample. The collected lip images may be divided into different subsets based on a lip shape, for example, based on an opening size between the lips, and each subset may correspond to one lip shape. Subsequently, a location of a key point may be indicated in each lip image. Finally, a plurality of lips precision models may be obtained by training, for each subset, an image having a key point of a lip contour indicated in the image. For example, when an image having a key point of a lip contour indicated in the image is trained using one subset, a corresponding lips precision model may be obtained. Using the obtained lips precision model, a key point of a lip contour may be detected in a lip image having a corresponding lip shape. Also, a lips precision model may be obtained through training using model recognition techniques according to related arts. For example, the lips precision model may be trained using a training method, for example, AdaBoost, based on different subsets.

According to other embodiments, each subset may be divided into secondary subsets along the lip shape based on the subset used in training the lips rough model as described in the foregoing, and the plurality of lips precision models may be trained using each secondary subset. For example, when training the lips rough model, the lip images may be divided into n subsets based on a head pose, and each subset may be divided into m secondary subsets based on a lip shape. In this instance, n x m secondary subsets may be obtained and n x m lips precision models may be trained. Here, because division into secondary subsets may be performed based on a head pose and a lip shape, the lips precision model may include a head pose and a lip shape that correspond to one another. Accordingly, when selecting a lips precision model in operation 104, a lips precision model having a most similar head pose and a most similar lip shape corresponding to the lips detected in operation 103 may be selected.

In operation 105, the lips may be detected using the selected lips precision model, and a final position of the lips. More particularly, an accurate position of the lips may be detected. For example, the detected lips may be represented by a location of a key point of a lip contour.

Also, when the lips are tracked based on a video, for example, a moving image, the method of FIG. 1 may be performed for each frame to be tracked or each tracked frame of the video.

Hereinafter, a description of a model used for the lips rough model and the lips precision model according to an exemplary embodiment is provided. The models may be used to implement accurate modeling of the lips.

The lips model according to an exemplary embodiment may include a shape model and/or a presentation model.

Shape Model

A shape model may be used to represent a geometric location of a key point of a lip contour, and may be expressed by Equation 1.

$$SHAPE ( P , q ) = s = N ( {s}_{0} + {\sum }_{i = 1}^{m} {p}_{i} {s}_{i} ; q ) \qquad [ Equation 1 ]$$

Here, a vector s set to an output of a shape model SHAPE(P,q) denotes a lip shape, a vector S₀ denotes an average shape of lips, Sᵢ denotes a shape primitive of lips, Pᵢ denotes a shape parameter corresponding to Sᵢ, a vector q denotes a similarity transformation parameter, i denotes an index of the shape primitive, m denotes a number of shape primitives, and N() denotes a function for performing a similarity transformation

$${s}_{0} + {\sum }_{i = 1}^{m} {p}_{i} {s}_{i}$$

using the vector q. Also, SHAPE(P, q) denotes a shape model in which P and q are set to be an input, and P denotes a set of numbers m of Pᵢ and may correspond to a shape parameter vector.

In the shape model, the vector s may be represented as coordinates indicating a vertex of a lip shape, and the vertex may correspond to a key point of a lip contour. The average shape vector S₀ denotes an average shape of lips, and each shape primitive Sᵢ denotes one change of the average shape. For one lip image, a lip shape may be represented by a similarity transformation of one lip shape represented using the average shape vector S₀, the shape primitive Sᵢ, and the corresponding shape parameter Pᵢ.

The average shape vector S₀ and the shape primitive Sᵢ may correspond to an intrinsic parameter of a shape model, and may be obtained through sample training. An average shape of a training sample may be obtained from a training sample set used for training a current model.

For example, the average shape vector S₀ and the shape primitive Sᵢ may be obtained by analyzing a principal component of a training sample set used for training a current model. More particularly, coordinates of a key point of a lip contour indicated in each training sample may be set to be a shape vector s, and an average value of shape vectors s obtained from all training samples included in a training sample set may be calculated and set to be an average shape vector S₀. Each shape primitive Sᵢ may denote an eigenvector of a covariance matrix for a shape vector of a training sample. An eigenvector of a covariance matrix for shape vectors of all or a portion of training samples of a training sample set, for example, m training samples, may be selected and set to be a shape primitive.

In an exemplary embodiment, an eigenvalue and/or an eigenvector of the covariance matrix may be calculated. As the eigenvalue increases, the eigenvector may be found to be a principal change mode in the training sample. Accordingly, eigenvectors of a plurality of covariance matrices having a large eigenvalue may be selected and may be set to be a shape primitive. For example, a sum of eigenvalues corresponding to eigenvectors of a plurality of covariance matrices may be greater than a preset percentage, for example, 90%, of a sum of all eigenvalues.

In an exemplary embodiment, the vector s may be set to s=(x₀, y₀, x₁, y₁, x₂, y₂, . . . )_{T}, and may include coordinates of a key point of a lip contour.

The average shape vector S₀ may be set to s₀=(x_{0,0}, y_{0,0}, x_{0,1}, y_{0,1}, x_{0,2}, y_{0,2}, . . . )_{T}, in which a first subscript 0 of each element denotes an average shape vector and a second subscript denotes an element index of the vector S₀.

The shape primitive Si may be set to sᵢ=(x_{i,0}, y_{i,0}, x_{i,1}, y_{i,1}, x_{i,2}, y_{i,2}, . . . )_{T}, in which a first subscript i of each element denotes a shape primitive and indicates a specific primitive. For example, in a case of m primitives in which m corresponds to an integer of 1 or more, a numerical range of i is [1, m] and a second subscript denotes an element index of the shape primitive Si.

The vector q of the similarity transformation parameter may be set to q=(f,θ,tₓ, t_{y})^{T}, in which f denotes a scaling factor, θ denotes a rotation angle, tₓ denotes a horizontal shift parameter, and t_{y} denotes a vertical shift parameter.

Here, each coordinate (xₖ, yₖ) of the vector s may be represented by Equation 2.

$$( \begin{matrix}{x}_{k} \\ {y}_{k}\end{matrix} ) = f \cdot ( \begin{matrix}cos θ & - sin θ \\ sin θ & cos θ\end{matrix} ) ( \begin{matrix}{x}_{0 , k} + {\sum }_{i} {p}_{i} {x}_{i , k} \\ {y}_{0 , k} + {\sum }_{i} {p}_{i} {y}_{i , k}\end{matrix} ) + ( \begin{matrix}{t}_{x} \\ {t}_{y}\end{matrix} ) \qquad [ Equation 2 ]$$

Here, representation of the vector may be exemplary, and may be defined by other mathematical representations. Also, the similarity transformation parameter q is not limited to a scaling factor, a rotation angle, a horizontal shift parameter, and a vertical shift parameter, and may include at least one parameter of a scaling factor, a rotation angle, a horizontal shift parameter, and a vertical shift parameter or other parameters for similarity transformation. For example, other algorithms for similarity transformation may be used.

Presentation model

A presentation model may be used to present an image of lips and a neighborhood or surrounding area of the lips, and may be represented by Equation 3.

$$APPEAR ( b ) = a = {a}_{0} + {\sum }_{i = 1}^{n} {b}_{i} {a}_{i} \qquad [ Equation 3 ]$$

A vector a denotes a presentation vector, a vector a₀ denotes an average presentation vector, bᵢ denotes a presentation parameter, a denotes a presentation primitive, bᵢ denotes a presentation parameter corresponding to the presentation primitive a, i denotes an index of the presentation primitive, and n denotes a number of presentation primitives. Also, APPEAR(b) denotes a presentation model in which b is set to be an input, and b denotes a set of n vectors of bᵢ.

In the presentation model, the presentation vector may include a pixel value of a lip texture image unrelated to a shape, such as a shape of the lips. The average presentation a₀ may denote an average value of presentation vectors in a training sample, and the presentation primitive a may denote one change of the average presentation a₀. For one lip image, a presentation vector of lips may be represented by one vector represented using the average presentation a₀, the presentation primitive aᵢ, and the corresponding presentation parameter bᵢ.

The average presentation a₀ and the presentation primitive aᵢ may correspond to an intrinsic parameter of a presentation model, and may be obtained through sample training. The average presentation a₀ and the presentation primitive aᵢ may be obtained from a training sample set used for training a current model.

For example, the average presentation a₀ and the presentation primitive aᵢ may be obtained by analyzing a principal component of a training sample set used for training a current mode. More particularly, a presentation vector a may be obtained from each training sample, and an average value of presentation vectors obtained from all training samples may be calculated and may be set to be the average presentation vector a₀. Each presentation primitive aᵢ may denote an eigenvector of a covariance matrix for a presentation vector a of one training sample. An eigenvector of a covariance matrix for a presentation vector a of all or a portion of training samples, for example, n training samples included in a training sample set may be selected and may be set to be a presentation primitive.

In an exemplary embodiment, an eigenvalue and/or an eigenvector of the covariance matrix may be calculated. As the eigenvalue increases, the corresponding eigenvector may be found to be a principal change mode in the training sample. Accordingly, eigenvectors of a plurality of covariance matrices having a large eigenvalue may be selected and may be set to be a presentation primitive. For example, a sum of eigenvalues corresponding to eigenvectors of a plurality of covariance matrices may be greater than a preset percentage, for example, 90%, of a sum of all eigenvalues.

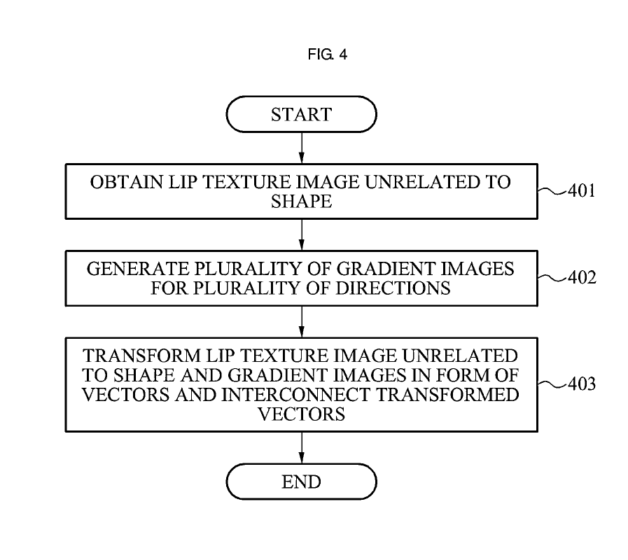

FIG. 4 is a flowchart illustrating a method of obtaining a presentation vector from a training sample according to an exemplary embodiment.

In operation 401, a lip texture image unrelated to a shape of the lips may be obtained by mapping, onto a generic or an average lip shape, a pixel inside the lips of a training sample and a pixel within a preset range outside the lips based on a location of a key point of a lip contour indicated in the training sample.

The pixel inside the lips may correspond to a pixel located within the lips in an image. The pixel within the preset range outside the lips may correspond to a pixel located out of the lips but a pixel having a distance, less than a preset threshold value, to a nearest pixel located within the lips.

In operation 402, a plurality of gradient images may be generated for a plurality of directions of the lip texture image unrelated to the shape. For example, a horizontal gradient image and a vertical gradient image may be obtained by performing convolution on an image using a Sobel operator in a horizontal direction and a vertical direction, respectively.

In operation 403, the lip texture image unrelated to the shape and the gradient image may be transformed in a form of a vector, and a presentation vector of the lips may be obtained by interconnecting the transformed vectors. Here, the transformed vector may correspond to a pixel value of the image.

For example, when the lip texture image unrelated to the shape and the gradient image has a size of 100×50 pixels, a third gradient image may be obtained. Accordingly, a number of elements of a final presentation vector may be 4×100×50.

Here, the method may obtain a presentation vector a in a sample during model training and may use the presentation vector a for the purpose of training, however, the presentation vector a may also be used as a result of detection. In this instance, the presentation vector a may include pixel values of the lip texture image unrelated to the shape and the gradient image based on the result of detection.

Operation 402 may be omitted selectively. In this instance, the presentation vector a may include only a pixel value of the lip texture image unrelated to the shape. In this case, accuracy of modeling and detection may be slightly reduced.

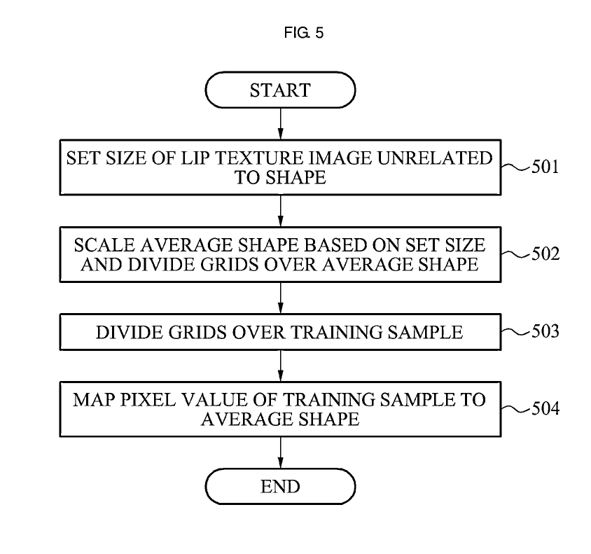

FIG. 5 is a flowchart illustrating a method of obtaining a lip texture image unrelated to a shape of the lips according to an exemplary embodiment.

In operation 501, a size of a lip texture image unrelated to a shape of the lips may be set. For example, the size may be set to 100×50 pixels.

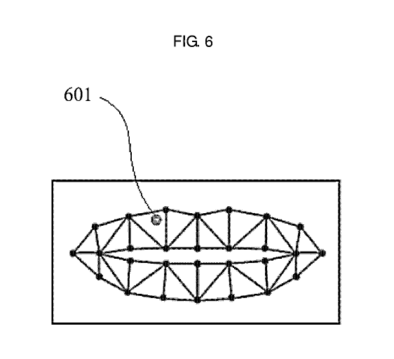

In operation 502, an average shape a₀ of lips may be divided into grids, for example, preset triangular grids, based on a vertex of the average shape a₀ within the set size range, by scaling the average shape a₀. FIG. 6 illustrates an example of grids divided based on a vertex of an average shape.

Also, in alternative embodiments, operation 501 may be omitted, and a size of the average shape a₀may be used directly.

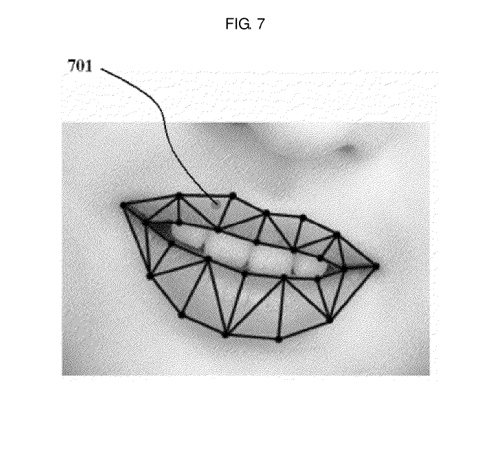

In operation 503, grids may be divided over a lip image with a key point set as a training sample using a grid dividing method, for example, as in operation 502. FIG. 7 illustrates an example of dividing grids over a lip image set as a training sample.

In operation 504, a lip texture image unrelated to a shape of the lips may be obtained by mapping or assigning pixel values of a pixel inside the lips of the lip image and a pixel within a preset range outside the lips to corresponding pixels in the average shape based on the divided grids.

For example, a pixel corresponding to a pixel of the lip image may be searched for in the average shape based on the divided grids since grids are divided over the average shape and the lip image using the same method. For example, a corresponding pixel may be searched for by referring to each triangular grid. Also, a point 601 corresponding to a point 701 of FIG. 7 may be searched for in FIG. 6 using the divided grids, and a pixel value of the point 701 may be assigned to the point 601.

Also, in operation 502, lip contour points or divided grids on the lip texture image unrelated to the shape may be stored and used to detect the lips. Also, when the size of the average shape a₀ is used directly, lip contour points included in the average shape in the process of detection may be used directly without being stored.

Here, the method of obtaining the lip texture image unrelated to the shape based on the grids shown in FIG. 5 is exemplary, and a pixel value of a training sample may be assigned to a corresponding pixel of an average shape using other methods.

The lips model including the shape model and the presentation model may be trained by a lips rough model or a lips precision model based on the training sample set used as described in the foregoing.

Hereinafter, application of the lips model including the shape model and the presentation model according to an exemplary embodiment to each operation of FIG. 1 is described.

The input image may include the first frame of the video, and the method of detecting lips may further include calculating a shape parameter vector for each of the plurality of the lips precision models, when selecting a k-th lips precision model among the plurality of the lips precision models, selecting the lips precision model in a current frame rather than the first frame, and detecting the lips in the current frame using the lips precision model.

Referring to FIG. 1, in operation 102, a lips rough model may be selected based on a head pose. However, exemplary embodiments are not limited thereto. In other embodiments, when detecting or tracking lips included in a video image, a lips rough model may be selected based on a result of detecting or tracking the lips in a previous frame, and the lips may be tracked in a current frame. More particularly, when a result of detecting or tracking the lip shape in a previous frame of a video is Sₚᵣₑ, in order to select a lips rough model, a parameter of a shape model included in each lips rough model, for example, a shape parameter vector P and a similarity transformation parameter q, may be calculated using Equation 4.

$${( P , q )}^{T} = {arg min}_{p , q} {‖ {S}_{pre} - SHAPE ( P , q ) ‖}^{2} \qquad [ Equation 4 ]$$

Here, q denotes a similarity transformation parameter, Sₚᵣₑ denotes a result of estimating the lips in a previous frame of the video, and SHAPE(P,q) denotes an output of a shape model. k may be set by Equation 5 below. Here, T denotes transpose, ∥ ∥² denotes a square of a vector length, and SHAPE(P,q) denotes an output of a shape model.

When a k-th lips rough model corresponds to the selected lips rough model, a shape parameter vector of the k-th lips rough model calculated by Equation 4 may be P^{k}. In this instance, the k-th lips rough model may be selected using Equation 5.

$$k = arg min {{‖}_{k} {e}_{k}^{- 1} {P}^{k} ‖}^{2} \qquad [ Equation 5 ]$$

Here, eₖ⁻¹ denotes a matrix, in which a diagonal element of the matrix denotes a reciprocal of an eigenvalue of a covariance matrix corresponding to each shape primitive when training a shape model of the k-th lips rough model, and remaining elements are zero, and P^{k} denotes a shape parameter vector of the k-th lips rough model among the plurality of the lips rough models.

For example, when Equation 5 is minimized by P^{k} calculated by Equation 4 among shape parameter vectors P of a plurality of lips rough models and a corresponding , the corresponding k-th lips rough model may be selected. Here, k may be an important variable in Equation 5, and may correspond to a positive (+) integer less than or equal to a number of lips rough models.

When detecting or tracking lips in a frame of a video image, a lips rough model may be selected based on a head pose. For example, a lips rough model may be selected based on a head pose in a portion of frames including, for example, a first frame, and a lips rough model may be selected in other frame based on a result of a previous frame.

Using a lips rough model including a shape model and a presentation model according to an exemplary embodiment, after selecting the lips rough model, the selected lips rough model may be initialized with respect to a shape and initialization may be performed using P and q of the k-th lips rough model calculated during selecting of the lips rough model. For example, parameters P and q may be initialized.

Referring to FIG. 1, in operation 101, a position of the lips may be represented by a key point of a lip contour surrounding the lips, and when a result of detecting or tracking the lips in a previous frame is present, initial values of P and q may be calculated by Equation 4 and a detection rate may be improved. In operation 101 of FIG. 1, a position of the lips may be represented by a square, and when use of a detecting or tracking result of a previous frame is not possible, initial values of P and q may be set to an arbitrary value, for example, zero. Also, a parameter b of a presentation model of the lips rough model may be initialized and may be set to an arbitrary value, for example, zero.

Referring to FIG. 1, when the lips rough model is initialized, an energy function may be minimized by Equation 6 and an initial detection of the lips may be executed in operation 103.

E₁=k₁₁E₁₁+k₁₂E₁₂+k₁₃E₁₃ [Equation 6]

Here, E₁₁ denotes a presentation bound term, E₁₂ denotes an internal transform bound term, E₁₃ denotes a shape bound term, and k₁₁, k₁₂, and k₁₃ denote weighting factors.

The weighting factors k₁₁, k₁₂, and k₁₃ may be obtained through an experiment. For example, values of k₁₁, k₁₂, and k₁₃ may be all set to 1. Also, the weighting factors k₁₁, k₁₂, and k₁₃ may be adjusted based on an actual condition. For example, as an image quality is high, k₁₁ may be set to a higher value. Also, as a size of a lip texture image unrelated to a shape of the lips is larger, k₁₁ may be set to a higher value.

The presentation bound term E₁₁ denotes a difference between a presentation of the detected lips and a presentation model. This may aid in implementation of the fitted lips to have the same presentation as the model. Here, E₁₁ may be represented by Equation 7.

$${E}_{11} = {\sum }_{i = 1}^{t} {‖ a ( {x}_{i} ) - I ( s ( {x}_{i} ) ) ‖}^{2} \qquad [ Equation 7 ]$$

Here, a(xᵢ) denotes a pixel value of a pixel x, among pixels of a lip texture image unrelated to a shape of the lips included in a presentation vector a. Also, t denotes a number of pixels of a lip texture image unrelated to a shape, and s(xᵢ) denotes a location of a pixel xᵢ in an input image. I(s(xᵢ)) denote a pixel value of a pixel of a location s(xᵢ) in an input image.

To minimize Equation 6, a(xᵢ) may be changed. Accordingly, a(xᵢ) may be changed by changing a parameter b of a presentation model APPEAR(b) and by changing an output presentation vector a of the presentation model APPEAR(b).

Here, a location of a pixel in an input image may be determined using a key point of a lip contour represented by a shape vector s based on a key point of a lip contour or a location relationship between a grid and a pixel xᵢ in a lip texture image unrelated to a shape of the lips. For example, (a pixel xᵢ and a key point of a lip contour or a location relationship of a grid in a lip texture image unrelated to a shape)=(a location of a pixel xᵢ in an input image (for example, a pixel in an input image corresponding to a pixel xᵢ) and a key point of a lip contour represented by a shape vector s or a location relationship of a grid generated by the key point of the lip contour)). Accordingly, the location of the pixel xᵢ in the input image may be obtained through the lip contour key point represented by the shape vector s using the location relationship.

As described in the foregoing, the key point of the lip contour in the lip texture image unrelated to the shape may correspond to a key point of a lip contour represented by an average presentation a₀ of a shape model, a key point of a lip contour in operation 502, or a point of a lip texture image unrelated to a shape of the lips in operation 504. A grid of a lip texture image unrelated to a shape of the lips may correspond to a grid generated by the point.

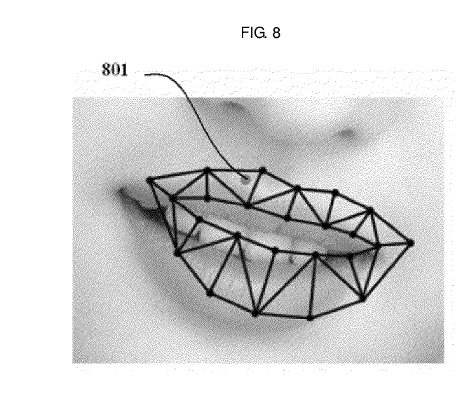

Referring to FIG. 6, the pixel 601 may be considered an example of a pixel xᵢ of a lip texture image unrelated to a shape of the lips. In this instance, a key point of a lip contour represented by a shape vector s may be as shown in FIG. 8. FIG. 8 illustrates a detecting result of an input image in a process of minimizing an energy function. A location 801 of a pixel xᵢ in an input image based on a key point of a lip contour or a grid in FIG. 8 may be determined based on the pixel 601 and a key point of a lip contour or a location relationship of a grid in FIG. 6. Here, when P or q is changed, the key point of the lip contour or the grid of FIG. 8 may be changed, and consequently, the location 801 may be changed.

The internal transform bound term E₁₂ may indicate a difference between a shape of the detected lips and an average shape. This may serve to prevent an excessive transformation of a model which may cause an error in detection or tracking. Here, E₁₂ may be represented by Equation 8.

E₁₂=∥e⁻¹P∥² [Equation 8]

Here, e⁻¹ denotes a matrix, in which a diagonal element of the matrix denotes a reciprocal of an eigenvalue of a covariance matrix corresponding to each shape primitive when training a shape model of a lips rough model, and remaining elements of the matrix are zero.

The shape bound term E₁₃ may indicate a difference between an estimated position of lips and a position of lips represented by a shape vector s. This may serve to apply an external constraint to a position and a shape of a model. Here, E₁₃ may be represented by Equation 9.

E₁₃=(s−s^{*})^{T}W(s−s^{*}) [Equation 9]

W denotes a diagonal matrix for weighting, and s^{*} denotes a position of lips obtained in operation 101. When the position of the lips obtained in operation 101 is represented by a key point of a contour, s^{*} may correspond to a coordinate vector including the key point. When the position of the lips obtained in operation 101 is represented by a square, s^{*} may include vertical coordinates of upper and lower edges and horizontal coordinates of left and right edges of the square.

When a shape vector is s=(x₀, y₀, x₁, y₁, x₂, y₂, . . . , xₑ₋₁, yₑ₋₁)^{T}, a length of the vector s may be 2c in which c denotes a number of vertices of a shape, for example, a number of key points of a lip contour. Accordingly, a diagonal matrix W may be represented as diag(d₀, d₁, d_{2c-1}). An element d₂ₖ (k≧0, K: integer) of a diagonal denotes a degree of similarity that Xₖ present in a current s is to be similar to an external constraint, and an element d₂ₖ₊₁ of a diagonal denotes a degree of similarity that Yₖ present in a current s is to be similar to an external constraint. The element of the diagonal W may be set manually based on situation. More particularly, as a probability is lower that one key point of a lip contour shifts in one direction, for example, a horizontal or x-axis direction or a vertical or y-axis direction in a process of detecting or tracking the lips, a diagonal element corresponding to the direction among two diagonal elements corresponding to the key point of the lip contour in the diagonal matrix W may be set to be greater. For example, as a probability is lower that a key point (Xₖ,Yₖ) of a lip contour present in s shifts in an x-axis direction or a y-axis direction in an actual application process, d₂ₖ or d₂ₖ₊₁ of a diagonal matrix W may be set to be greater.

For example, for two diagonal elements of W corresponding to x, y coordinates of a lower edge center point of lips, when detection or tracking of the lips supports voice recognition, a principal motion mode of the lips may be open and closed. A diagonal element of W corresponding to x may be set to be greater and a horizontal shift of a lower lip may be limited because the point does not shift in a horizontal direction. In contrast, when detection or tracking of a lip shape is needed in an application process, rather than left and right symmetry, an element of W corresponding to an x coordinate of the point may be set to be smaller.

When a minimum value is obtained by minimizing E1 through changing a model parameter, a shape vector s of a lips rough model may correspond to a result of initial estimation of the lips.

Here, a process of minimizing Equation 6 may correspond to a process of adjusting parameters P, q, and b substantially.

According to other embodiments, when lips are detected or tracked based on a video image, a lips precision model may be selected by tracking the lips in a current frame based on a detecting or tracking result of a previous frame in operation 104 of FIG. 1. In this instance, the lips precision model may be selected using Equations 4 and 5.

More particularly, when a result of detecting or tracking the lip shape in a previous frame is Sₚᵣₑ, in order to select a lips precision model, a parameter of a shape model included in each lips precision model, for example, a shape parameter vector P and a similarity transformation parameter q may be calculated using Equation 4.

When a k-th lips precision model corresponds to a desired lips precision model, a shape parameter vector of the k-th lips precision model calculated using Equation 4 may be P^{k}, and a lips precision model may be selected using Equation 5. In this instance, a diagonal element of eₖ⁻¹ denotes a reciprocal of an eigenvalue of a covariance matrix corresponding to each shape primitive when training a shape model of the k-th lips precision model, and remaining elements of the matrix are zero.

Here, when the lips are detected and tracked based on a video image, the lips precision model may be selected by a method used in operation 104.

According to other embodiments, Equation 6 may include at least one of E₁₁, E₁₂, and E₁₃. For example, E₁ may be restricted using at least one of E₁₁, E₁₂, and E₁₃. Here, to use at least one of E₁₁, E₁₂, and E₁₃, each of the lips rough model and the lips precision model may include one or both of the shape model and the presentation model.

After the lips precision model is selected, the selected lips precision model may be initialized. For example, parameters P, q, and b may be initialized. This may be the same as the initialization of the lips rough model, and thus a detailed description is omitted herein for conciseness and ease of description.

Referring to FIG. 1, when the lips precision model is initialized, an energy function may be minimized and a final position of the lips may be detected through Equation 10 in operation 105.

E₂=k₂₁E₂₁+k₂₂E₂₂+k₂₃E₂₃ [Equation 10]

Here, E₂₁ denotes a presentation bound term, E₂₂ denotes an internal transform bound term, E₂₃ denotes a shape bound term, and k₂₁, k₂₂, and k₂₃ denote weighting factors.

The presentation bound term (E₂₁) may be set by Equation 11.

$${E}_{21} = {\sum }_{i = 1}^{t} {‖ a ( {x}_{i} ) - I ( s ( {x}_{i} ) ) ‖}^{2} \qquad [ Equation 11 ]$$

Here, a(xᵢ) denotes a pixel value of a pixel x, among pixels of a lip texture image unrelated to a shape of the lips included in a presentation vector a, t denotes a number of pixels of a lip texture image unrelated to a shape, and s(xᵢ) denotes a location of a pixel xᵢ in an input image. I(s(xᵢ)) denote a pixel value of a pixel of a location s(xᵢ) in an input image.

The internal transform bound term (E₂₂) may be set by Equation 12.

E₂₂=∥e⁻¹P∥² [Equation 12]

Here, e⁻¹ denotes a matrix, in which a diagonal element of the matrix denotes a reciprocal of an eigenvalue of a covariance matrix corresponding to each shape primitive when training a shape model of the lips precision model, and remaining elements are zero

The shape bound term (E₂₃) may be set by Equation 13.

E₂₃=(s−s^{*})^{T}W(s−s^{*}) [Equation 13]

Here, W denotes a diagonal matrix for weighting, and s^{*} denotes the initially detected lips, and s denotes an output of the shape model.

The method of detecting lips may further include calculating the Gaussian mixture model corresponding to the pixel xi. The calculating of the Gaussian mixture model corresponding to the pixel xi may include detecting the lips in a predetermined number of frames using the selected lips precision model based on a weighted sum of at least one term of a presentation bound term, an internal transform bound term, a shape bound term, and a texture bound term, obtaining a predetermined number of texture images unrelated to the shape based on a result of the detection, and forming a Gaussian mixture model by constructing a cluster using a pixel value corresponding to the pixel xᵢ in the predetermined number of obtained texture images unrelated to the shape.

The calculating of the Gaussian mixture model corresponding to the pixel xi may include (b1) detecting the lips in one frame using the selected lips precision model based on a weighted sum of at least one term of a presentation bound term, an internal transform bound term, a shape bound term, and a texture bound term, (b2) when the detected lips are in a non-neutral expression state, performing the operation (b1), (b3) when the detected lips are in a neutral expression state, extracting a pixel value corresponding to the pixel xi in the lip texture image unrelated to the shape based on a result of the detection, (b4) when a number of the extracted pixel values corresponding to the pixel xi is less than a preset number, performing the operation (b1), and (b5) when the number of the extracted pixel values corresponding to the pixel xi is greater than or equal to the preset number, forming a Gaussian mixture model by constructing a cluster using the preset number of the extracted pixel values corresponding to the pixel xᵢ.

The method of detecting lips may include updating the texture model after using the texture model. The updating of the texture model after using the texture model may include, when the lips detected using the selected lips precision model when using the texture model are in a non-neutral expression state, calculating an absolute value of a difference between a pixel value of the pixel xᵢ in a lips texture image unrelated to a shape based on the detected lips and each cluster center value of the Gaussian mixture model corresponding to the pixel xᵢ updating the Gaussian mixture model corresponding to the pixel xᵢ using the pixel value when a minimum value of the calculated absolute value is less than a preset threshold value, and constructing a new cluster using the pixel value and updating the Gaussian mixture model corresponding to the pixel xᵢ when the minimum value of the calculated absolute value is greater than or equal to the preset threshold value and a number of clusters of the Gaussian mixture model corresponding to the pixel xᵢ is less than a preset threshold value.

A representation scheme of the presentation bound term E₂₁ may be the same as that of the presentation bound term E₁₁ described in the foregoing. A representation scheme of the internal transform bound term E₂₂ may be the same as that of the internal transform bound term E₂₁ described in the foregoing. A representation scheme of the shape bound term E₂₃ may be the same as that of the shape bound term E₁₃ described in the foregoing. Here, s^{*} denotes a position of the initially detected lips in operation 103. Accordingly, a detailed description of the presentation bound term E₂₁, the internal transform bound term E₂₂, the shape bound term E₂₃ is omitted herein.

The weighting factors k₂₁, k₂₂, and k₂₃ may be obtained through an experiment. For example, values of k₂₁, k₂₂, and k₂₃ may be set to 1. Also, the weighting factors k₂₁, k₂₂, and k₂₃ may be adjusted based on an actual condition. For example, the higher a quality of an image, and the larger a size of a lip texture image unrelated to a shape of the lips, the higher a value of k₂₁.

According to other embodiments, Equation 10 may include at least one of E₂₁, E₂₂, and E₂₃. For example, E₂ may be restricted using at least one of E₂₁, E₂₂, and E₂₃.

Also, according to other embodiments, referring to FIG. 1, when the lips precision model is initialized, an energy function may be minimized and a final position of the lips may be detected by Equation 14 in operation 105.

E₃=k₂₁E₂₁+k₂₂E₂₂+k₂₃E₂₄+k₂₄E₂₄ [Equation 14]

Here, E₂₁ denotes a presentation bound term, E₂₂ denotes an internal transform bound term, E₂₃ denotes a shape bound term, E₂₄ denotes a texture bound term, and k₂₁, k₂₂, and k₂₃ denote weighting factors.

The texture bound term E₂₄ may be defined based on a texture model. The texture bound term E₂₄ may not be applied before generating a texture model. The texture model may be obtained through statistics of pixel colors of the lips and a neighborhood of the lips in a current video, and may represent a tracked texture feature of a target in the current video. The texture model may differ from a presentation model. While a presentation model is obtained by training a great number of sample images, the texture model may be generated and updated in a process of tracking the video. For example, this exemplary embodiment may be more suitable for tracking the lips based on a video or a moving picture.

According to other embodiments, Equation 14 may include at least one of E₂, E₂₂, and E₂₃. For example, E₃ may be restricted using at least one of E₂, E₂₂, and E₂₃.

The texture bound term E₂₄ may be represented by Equation 15.

$${E}_{24} = {\sum }_{i = 1}^{t} {[ P ( I ( s ( {x}_{i} ) ) ) ]}^{2} \qquad [ Equation 15 ]$$

Here, t denotes a number of pixels in a lip texture image unrelated to a shape of the lips, xᵢ denotes a pixel in a lip texture image unrelated to a shape of the lips, and s(xᵢ) denotes a location of a pixel xᵢ in an input image. I(s(xᵢ)) denotes a pixel value of a pixel of a location s(xᵢ) in an input image, and P(I(s(xᵢ))) denotes a reciprocal of a probability density obtained using a value of I(s(xᵢ)) as an input of a Gaussian mixture model (GMM) corresponding to a pixel xᵢ.

The parameter I(s(xᵢ)) is described in Equation 7 in the foregoing, and thus a detailed description is omitted herein.

Each pixel of a lip texture image unrelated to a shape of the lips may correspond to a Gaussian mixture model. The Gaussian mixture model may be modeled and generated using a pixel value of a corresponding pixel in different frames of a video. For example, a texture model may correspond to a combination of a series of Gaussian mixture models, and the Gaussian mixture model may correspond to a pixel of a lip texture image unrelated to a shape.

At the start of tracking of the lips in a video, a texture model may not yet be generated. In this instance, operation 105 may be performed using Equation 10. Subsequently, the lips may be tracked in a frame of a video and a texture image unrelated to a shape may be obtained, for example, from a presentation vector a, based on a result of the tracking. When a number of the obtained texture images unrelated to a shape is greater than a preset threshold value, a Gaussian mixture model may be calculated using the texture images unrelated to the shape for each pixel of the texture image unrelated to the shape, and a texture model may be generated. For example, a size of the texture image unrelated to the shape may be fixed, and a plurality of samples may be obtained for each pixel of each location in the texture image unrelated to the shape, and a Gaussian mixture model may be obtained using the samples. According to other embodiments, for a pixel (Xₓ,Y_{y}) of a texture image unrelated to a shape, a plurality of pixel values of the pixel (Xₓ,Y_{y}) may be obtained in the texture image unrelated to the shape based on a plurality of results of tracking, and a Gaussian mixture model corresponding to the pixel Xₓ,Y_{y} may be calculated using the plurality of pixel values.

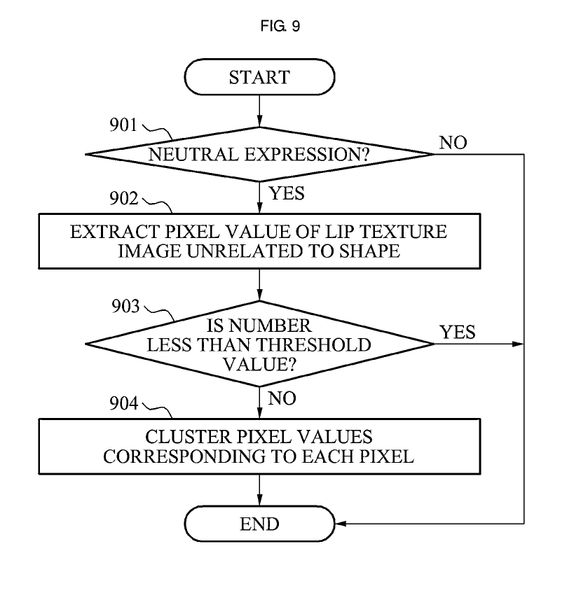

Hereinafter, an example of modeling a texture model is described with reference to FIG. 9. In this exemplary embodiment, for the purpose of modeling, a scheme of selecting a texture image unrelated to a shape based on an expression state may be improved. FIG. 9 is a flowchart illustrating modeling of a texture model according to an exemplary embodiment.

In operation 901, based on a result of a position of lips detected in operation 105, whether the detected lips are in a neutral expression state may be determined. Whether the lips are in a neutral expression state may be determined through a current value of the internal transformation bound term E₂₂ of Equation 14. For example, when the current value of the internal transformation bound term E₂₂ is greater than a preset threshold value, the detected lips may be determined to be in a neutral expression state. Here, the texture bound term E₂₄ may be invalid when using Equation 14 in operation 105 because a texture model is yet to be generated. In this instance, a final position of the lips may be detected using Equation 10 in operation 105.

Operation 901 may start from a first tracked frame of a video or an arbitrary tracked frame next to the first tracked frame. In an exemplary embodiment, operation 901 may be performed from the first tracked frame of the video.

When the lips are not in a neutral expression state in operation 901, a process may be terminated and operation 901 may be performed based on a result of tracking to be performed on a next tracked frame of the video.

When the lips are in a neutral expression state in operation 901, a pixel value of each pixel in a texture image unrelated to a shape may be extracted in operation 902. Here, the pixel value of each pixel in the texture image unrelated to the shape may be obtained from a presentation vector a of a selected lips precision model.

Next, whether a number of extracted lip texture images unrelated to the shape is greater than a predetermined threshold value may be determined in operation 903. For example, whether a number of samples is sufficient may be determined.

When a number of extracted lip texture images unrelated to the shape is less than the predetermined number in operation 903, a process may be terminated and operation 901 may be performed based on a result of tracking on a next tracked frame of the video.

When a number of extracted lip texture images unrelated to the shape is greater than or equal to the predetermined number in operation 903, a Gaussian mixture model may be formed, for each pixel of each location, by constructing a cluster using pixel values corresponding to pixels of a preset number of extracted lip texture images unrelated to the shape in operation 904. Forming a Gaussian mixture model by constructing a cluster based on a plurality of sample values is a well-known technology, and thus a detailed description is omitted herein.

Subsequently, the process may be terminated.

After a texture model is generated, the texture model may be applied to the tracked frame. For example, the texture bound term E₂₄ of Equation 14 may be applied.

According to other embodiments, when the texture model is generated and applied, the texture model may be updated.

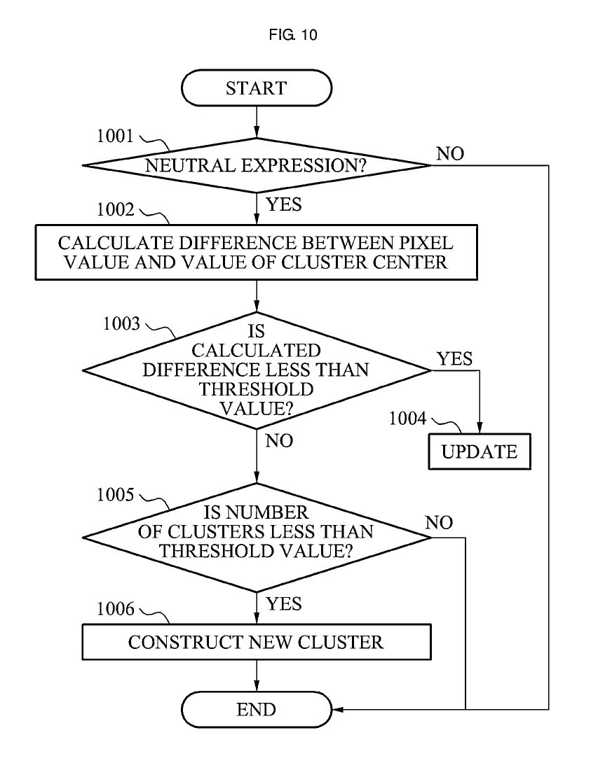

FIG. 10 is a flowchart illustrating a method of updating a texture model according to an exemplary embodiment.

In operation 1001, whether the detected lips are in a neutral expression state may be determined based on a result of a position of the detected lips in operation 105.

When the lips are not in a neutral expression state in operation 1001, a process may be terminated, and operation 1001 may be performed based on a result of tracking on a next tracked frame of a video.

When the lips are in a neutral expression state in operation 1001, in operation 1002, a distance between each pixel of a lip texture image unrelated to a shape of the lips and each cluster center of a Gaussian mixture model corresponding to the pixel may be extracted based on a tracking result of a current frame, and a minimum distance may be selected. For example, an absolute value of a difference between a pixel value of the pixel and each cluster center value may be calculated and a minimum absolute value may be selected.

Next, in operation 1003, whether the minimum distance corresponding to each pixel is less than a preset threshold value may be determined for each pixel.

When the minimum distance corresponding to the pixel is less than the preset threshold value in operation 1003, in operation 1004, the Gaussian mixture model corresponding to the pixel may be updated using the pixel value of the pixel. Subsequently, the process may be terminated, and operation 1001 may be performed based on a result of tracking on a next tracked frame of the video.

When a minimum distance corresponding to one pixel is great than or equal to the preset threshold value in operation 1003, whether a number of clusters of the Gaussian mixture model corresponding to the pixel is less than a preset threshold value may be determined in operation 1005.

When the number of clusters of the Gaussian mixture model corresponding to the pixel is less than the preset threshold value in operation 1005, the Gaussian mixture model corresponding to the pixel may be updated using the pixel value of the pixel in operation 1006.

When the number of clusters of the Gaussian mixture model corresponding to the pixel is greater than or equal to the preset threshold value in operation 1005, the process may be terminated and operation 1001 may be performed based on a result of tracking on a next tracked frame of the video.

The method of detecting and/or tracking lips according to an exemplary embodiment may be recorded in computer-readable media including program instructions to implement various operations embodied by a computer. The computer-readable media may be configured to store the method, to read data through a computer system, and to record data.

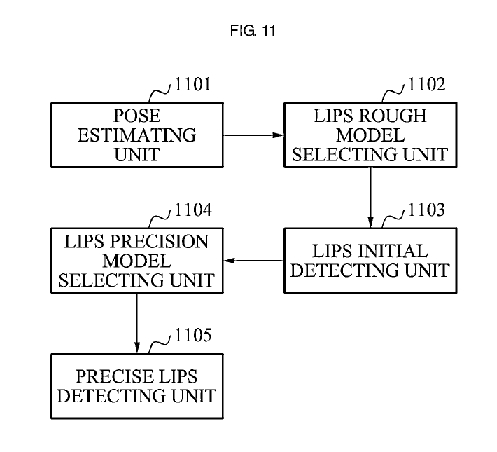

FIG. 11 is a block diagram illustrating an apparatus for detecting lips according to an exemplary embodiment.

Referring to FIG. 11, the apparatus for detecting lips according to an exemplary embodiment may include, for example, a pose estimating unit 1101, a lips rough model selecting unit 1102, a lips initial detecting unit 1103, a lips precision model selecting unit 1104, and a precise lips detecting unit 1105.

The pose estimating unit 1101 may estimate a position of lips and a corresponding head pose from an input image. The estimation of the lips and the head pose may be implemented using conventional techniques. Also, as described in the foregoing, the head pose may be estimated based on a relative position of the lips in the head.

Also, in an embodiment the lips detection apparatus may optionally include a face recognition unit (not shown). The pose estimating unit 1101 may detect a face region. The apparatus for detecting lips may perform a corresponding processing on the face region detected through the pose estimating unit 1101.

The lips rough model selecting unit 1102 may select a lips rough model corresponding to the head pose among a plurality of lips rough models based on the head pose, or may select a lips rough model most similar to the head pose.

Also, the lips rough model selecting unit 1102 may minimize an energy function by Equation 6, and may execute an initial detection of the lips.

The lips initial detecting unit 1103 may execute an initial detection of the lips, for example, a position of rough lips in the image, using the selected lips rough model. The detected lips may be represented by a location of a key point of a lip contour. FIG. 3 illustrates a key point of a lip contour according to an exemplary embodiment. As shown in FIG. 3, the key point of the lip contour may form a grid of a lip region.

The lips precision model selecting unit 1104 may select one lips precision model among a plurality of lips precision models based on a result of the initial detection of the lips. For example, a lips precision model having a lip shape most similar to a shape of the initially detected lips may be selected among a plurality of lips precision models.

The lips rough model and the lips precision model may be modeled and trained using the method described in the foregoing.

The precise lips detecting unit 1105 may detect precise lips and may obtain final lips using the selected lips precision model. Also, the precise lips detecting unit 1105 may minimize an energy function and may detect precise lips using Equation 10 or Equation 14.

Here, when detecting the lips for each frame of the video using the apparatus for detecting lips, the apparatus for detecting lips may be considered an apparatus for tracking lips.

Each unit of the apparatus for detecting lips according to an exemplary embodiment may be implemented using hardware components, software components, or a combination thereof. For example, the unit may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner.

The method/apparatus for detecting and/or tracking lips may be adapted to a variety of changes of a lip shape and may detect a key point of a lip contour accurately. Also, when a variety of changes occur in a head pose, the lip shape in the image or video may be changed, however, the key point of the lip contour may be detected accurately through the method/apparatus for detecting and/or tracking lips according to an exemplary embodiment. Also, high rigidity may be ensured against the influence by an environmental illumination and an image collecting apparatus. The method/apparatus for detecting and/or tracking lips according to an exemplary embodiment may detect a key point of a lip contour accurately even in an image having unbalanced lighting, a low brightness, and/or a low contrast. Also, a new lips modeling method for detecting and tracking the lips according to an exemplary embodiment may be provided, and accuracy and robustness of detection or tracking of the lips may be improved.

The methods according to exemplary embodiments may be recorded in computer- readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like.

Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa. Any one or more of the software modules/units described herein may be executed by a general-purpose or special purpose computer, as described above, and including a dedicated processor unique to that unit or a processor common to one or more of the modules.

Although a few exemplary embodiments have been shown and described, the present disclosure is not limited to the described exemplary embodiments. Instead, it would be appreciated by those skilled in the art that changes may be made to these exemplary embodiments without departing from the principles and spirit of the disclosure, the scope of which is defined by the claims and their equivalents.

What is claimed is:

1. A lips detecting method comprising:
estimating, by way of a processor, a head pose in an input image;
selecting a lips rough model corresponding to the estimated head pose from among a plurality of lips rough models;
executing an initial detection of lips using the selected lips rough model;
selecting a lips precision model having a lip shape most similar to a shape of the initially detected lips from among a plurality of lips precision models; and
detecting the lips using the selected lips precision model.

2. The method of claim 1, wherein the plurality of lips rough models are obtained by training lip images of a first multi group as a training sample, and
lip images of a respective group of the first multi group are used as a training sample set and are used to train a corresponding lips rough model.

3. The method of claim 2, wherein the plurality of lips precision models are obtained by training lip images of a second multi group as a training sample, and
lip images of a respective group of the second multi group are used as a training sample set and are used to train a corresponding lips precision model.

4. The method of claim 3, wherein the lip images of the respective group of the second multi group are divided into a plurality of subsets based on a lip shape,
the lips precision model is trained using the subsets, and
a respective subset, of the plurality of subsets, is used as a training sample set and is used to train a corresponding lips precision model.

5. The method of claim 1, wherein the lips rough model and the lips precision model each include at least one of a shape model and a presentation model,
the shape model is used to model the lip shape and corresponds to a similarity transformation on an average shape and a weighted sum of at least one shape primitive reflecting a shape change,
the average shape and the at least one shape primitive are set to be intrinsic parameters of the shape model,
a parameter for the similarity transformation and a shape parameter vector of the shape parameter for weighting the shape primitive are set to be variables of the shape model,
the presentation model is used to model a presentation of the lips, and corresponds to an average presentation of the lips and a weighted sum of at least one presentation primitive reflecting a presentation change,
the average presentation and the presentation primitive are each set to be intrinsic parameters of the presentation model, and
a weight for weighting the presentation primitive is set to be a variable of the presentation model.

6. The method of claim 5, wherein the detecting of the lips using the lips rough model comprises calculating a weighted sum of at least one term of a presentation bound term, an internal transform bound term, and a shape bound term,
the presentation bound term indicates a difference between the presentation of the detected lips and the presentation model,
the internal transform bound term indicates a difference between the shape of the detected lips and the average shape, and
the shape bound term indicates a difference between the shape of the detected lips and a pre-estimated position of the lips in the input image.

7. The method of claim 5, wherein the detecting of the lips using the lips precision model comprises calculating a weighted sum of at least one term of a presentation bound term, an internal transform bound term, a shape bound term, and a texture bound term,
the presentation bound term indicates a difference between the presentation of the detected lips and the presentation model,
the internal transform bound term indicates a difference between the shape of the detected lips and the average shape,
the shape bound term indicates a difference between the shape of the detected lips and the shape of the initially detected lips, and
the texture bound term indicates a texture change between a current frame and a previous frame.

8. The method of claim 5, wherein the average shape indicates an average shape of the lips included in a training sample set for training the shape model, and the shape primitive indicates one change of the average shape.

9. The method of claim 5, further comprising:
selecting an eigenvector of a covariance matrix for shape vectors of all or a portion of training samples in a training sample set, and setting the eigenvector of the covariance matrix to be the shape primitive.

10. The method of claim 9, further comprising:
when a sum of eigenvalues of a covariance matrix for shape vectors of a predetermined number of training samples in the training sample set is greater than a preset percentage of a sum of eigenvalues of a covariance matrix for shape vectors of all training samples in the training sample set,
setting the eigenvectors of the covariance matrix for the shape vectors of the predetermined number of training samples to be a predetermined number of shape primitives.

11. The method of claim 5, wherein the average presentation indicates an average value of presentation vectors of a training sample set for training the presentation model, and the presentation primitive indicates a change of the average presentation vector.

12. The method of claim 5, further comprising:
selecting an eigenvector of a covariance matrix for presentation vectors of all or a portion of training samples in a training sample set, and setting the eigenvector of the covariance matrix to be the presentation primitive.

13. The method of claim 12, further comprising:
when a sum of eigenvalues of a covariance matrix for presentation vectors of a predetermined number of training samples in the training sample set is greater than a preset percentage of a sum of eigenvalues of a covariance matrix for presentation vectors of all training samples in the training sample set,
setting the eigenvectors of the covariance matrix for the presentation vectors of the predetermined number of training samples to be a predetermined number of presentation primitives.

14. The method of claim 5, wherein the presentation vector includes a pixel value of a pixel of a lip texture image unrelated to a shape.

15. The method of claim 14, further comprising:
obtaining the presentation vector by the training,
wherein the obtaining of the presentation vector by the training comprises:
obtaining a lip texture image unrelated to a shape by mapping a pixel inside the lips and a pixel within a preset range of an outside of the lips onto an average shape of the lips based on a location of a key point of a lip contour represented in the training sample;
generating a plurality of gradient images for a plurality of directions of the lip texture image unrelated to the shape; and
obtaining the presentation vector by transforming the lip texture image unrelated to the shape and the plurality of gradient images in a form of a vector and by interconnecting the transformed vectors.

16. The method of claim 14, further comprising:
obtaining the lip texture image unrelated to the shape by the training,
wherein the obtaining of the lip texture image unrelated to the shape by the training comprises mapping a pixel inside the lips of a training sample and a pixel within a preset range of an outside of the lips to a corresponding pixel in the average shape based on a key point of a lip contour in the training sample and the average shape.

17. The method of claim 14, further comprising:
obtaining the lip texture image unrelated to the shape by the training,
wherein the obtaining of the lip texture image unrelated to the shape by the training comprises:
dividing grids over the average shape of the lips using a preset method based on a key point of a lip contour representing the average shape of the lips in the average shape of the lips;
dividing grids over a training sample including the key point of the lip contour using the preset method based on the key point of the lip contour; and
mapping a pixel inside the lips of the training sample and a pixel within a preset range of an outside of the lips to a corresponding pixel in the average shape based on the grid.

18. The method of claim 6, wherein the shape bound term is set to an equation:
E₁₃=(s−s^{*})^{T}W(s−s^{*})
where E₁₃ denotes the the shape bound term, W denotes a diagonal matrix for weighting, s^{*} denotes a position of the initially detected lips in the input image, and s denotes an output of the shape model.

19. The method of claim 7, wherein the texture bound term is set to an equation:
$${E}_{24} = {\sum }_{i = 1}^{t} {[ P ( I ( s ( {x}_{i} ) ) ) ]}^{2}$$
where E₂₄ denotes the the texture bound term, P(I(s(xᵢ))) denotes a reciprocal of a probability density obtained using a value of I(s(xᵢ)) as an input of a Gaussian mixture model (GMM) corresponding to a pixel xᵢ, I(s(xᵢ)) denotes a pixel value of a pixel of a location s(xᵢ) in the input image, and s(xᵢ) denotes the location of the pixel xᵢ in the input image.

20. A lips detecting method comprising:
selecting a lips rough model from among a plurality of lips rough models;
executing an initial detection of lips using the selected lips rough model;
selecting a lips precision model having a lip shape according to a shape of the initially detected lips from among a plurality of lips precision models; and
detecting the lips using the selected lips precision model.

21. A method of updating a texture model of an image, the method comprising:
detecting lips in the image;
determining whether the detected lips are in a neutral expression state based on a position of the detected lips;
extracting, when the lips are detected to be in the neutral expression state, a minimum distance between each pixel of a lip texture image unrelated to a shape of the lips and each cluster center of a mixture model corresponding, respectively, to each pixel of the lip texture image based on a tracking result of a current frame;
determining whether the minimum distance corresponding to each pixel is less than a preset threshold value; and
updating the mixture model corresponding to the pixel using a value of the pixel when the minimum distance corresponding to the each pixel is determined to be less than the preset threshold value.
